(19) United States
(12) Patent Application Publication
(10) Pub. No.: US 2011/0179776 A1
(43) Pub. Date: Jul. 28, 2011

(54) Tank for Working Fluids of Motor Vehicles

(75) Inventors: Martin Magnusson, Halmstad (SE); Paul Fletcher, Schwarzach (AT); Otto Feldner, Saalfelden (AT)

(73) Assignee: ALUTECH GESELLSCHAFT M.B.H., Lend (AT)

(21) Appl. No.: 13/057,611

(22) PCT Filed: May 29, 2009
(86) PCT No.: PCT/AT09/00223

§ 371 Date: Mar. 1, 2011

(30) Foreign Application Priority Data
Aug. 6, 2008 (AT) GM 422/2008

(51) Int. Cl. F01N 3/00; B60K 15/03

(52) U.S. Cl. 60/295

(57) ABSTRACT

The invention relates to a tank for working fluids of motor vehicles, comprising a metal wall, at least one opening therein, and a plastic coating on the inside of the metal wall, wherein the plastic coating extends through the opening at least to the level of the outside of the metal wall.

The present invention relates to a tank for working fluids of motor vehicles, having a metal wall, at least one opening therein, and a plastics coating on the inner side of the metal wall.

Metal tanks which are coated with plastics material at the inner side are required particularly for aggressive working fluids of motor vehicles, for example, urea solutions such as AdBlue®, which are used as catalytic fluids for cleaning the exhaust gas of diesel motors. The plastics coating is generally formed by rotolining inside (“in situ”) the tank. To that end, plastics granulate is introduced into the tank via the opening, the opening is closed and the tank is rotated whilst being heated until the plastics material uniformly melts on the inner side of the metal wall and forms a plastics coating at that location. Subsequently, the opening is unblocked again.

There is produced the problem that, according to the conventional prior art, parts of the metal wall may be exposed in the region of the edges of the opening and, as a result, may be subjected to the aggressive content of the tank, in particular when the tank is being filled or in the event of substantial shocks during operation. It may also occur that working fluids become introduced from the opening into the region between the metal wall and the plastics coating, travel under it and exert their aggressive effect extensively on the entire metal material of the tank.

An object of the invention is to overcome the disadvantages of the prior art and to provide a metal tank which is coated with plastics material, wherein it is substantially impossible for the tank content to come into contact with the metal wall of the tank in all operating phases. This object is achieved with a tank of the type set out in the introduction which is characterised according to the invention in that the plastics coating extends through the opening at least as far as the level of the outer side of the metal wall.

Aggressive working fluids are thereby effectively prevented from travelling under the plastics coating in the opening region and being able to endanger the metal structure of the tank as a result. At the same time, the edge regions and rims of the opening are also protected so that contact between the working fluids and the metal structure is prevented both during filling and during operation. Consequently, a completely closed “plastics bubble” for the aggressive tank content is produced after the opening is closed accordingly.

According to a first preferred embodiment of the invention, the plastics coating extends beyond the level of the outer side and is supported on the region of the outer side of the metal wall around the opening. The plastics coating is thereby directed outwards in a U-like manner around the edge of the rim of the opening so that the entire edge region is covered.

The opening constructed in this manner preferably receives a component, preferably a measurement value sensor, which extends into the tank and which is provided with an end flange, whose end flange engages over the plastics coating at the mentioned region of the outer side. On the one hand, protection of the plastics coating from external influences can thereby be achieved and, on the other hand, the plastics coating forms an excellent seal with the end flange.

The seal can be further improved if, according to another feature of the invention, the end flange has a seal for abutment against the plastics coating in the region mentioned.

In a second preferred embodiment of the invention, the plastics coating extends beyond the level of the outer side and the opening receives a sleeve which projects beyond the outer side of the metal wall and against the inner side of which the plastics coating abuts. With this variant of the invention, it is also possible to prevent both the aggressive tank content from travelling under the plastics coating in the opening region and the risk of the metal structure becoming wet during filling or during operation.

It is particularly advantageous when the sleeve mentioned receives a filler neck which is pressed into the plastics coating at the inner side of the sleeve, whereby it is possible to obtain additional sealing.

The filler neck can further be provided with an external thread and/or with external ribs for press-fit securing in the plastics coating, whereby the sealing action can be further improved.

It is particularly advantageous if the filler neck has, at the outer end thereof, a bent-over edge which engages around the outer end of the sleeve with the plastics coating thereof. The plastics coating is thereby completely protected from external influences and the danger of the plastics coating being travelled under is also prevented in this region.

Another preferred variant of the invention is characterised in that the sleeve and the filler neck have mutually complementary internal projections and the internal projection of the filler neck is fixed to the internal projection of the sleeve by way of fixing means which extend through the plastics coating. There are thereby achieved an additional sealing fold and axial compression between the filler neck and the sleeve.

The tank according to the invention may be produced from any metal, for example, sheet steel. However, the constructions set out here are particularly suitable for protecting tanks composed of aluminium and a preferred construction of the invention accordingly involves the metal wall and the optional sleeve being produced from aluminium.

The plastics coating can also be formed in any manner known in the art. It is particularly advantageous if the plastics coating is formed by rotolining in situ in the metal wall.

The tank of the invention is also suitable for receiving any working fluids of motor vehicles, for example, fuels based on crude oil, biofuels, ethanol, hydraulic oils or lubricating oils, etc. The construction set out is particularly suitable for tanks for receiving catalytic urea solutions and a particularly preferred embodiment of the invention is accordingly characterised in that the plastics coating is resistant to urea solutions.

The invention is explained in greater detail below with reference to embodiments which are illustrated in the appended drawings, in which:

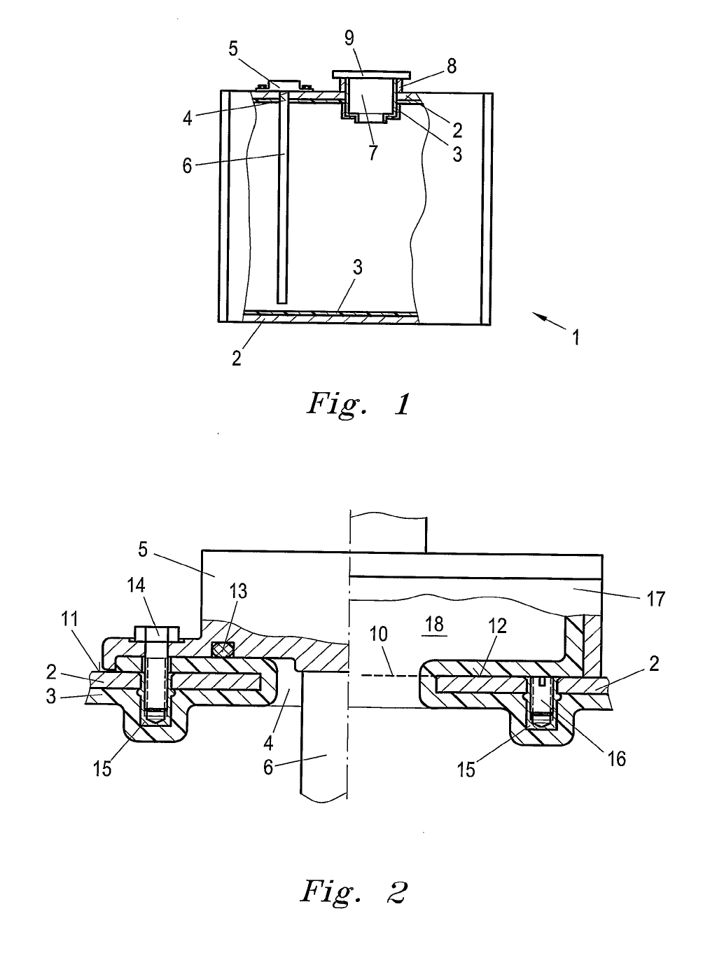

FIG. 1 is a sectional overview of the tank of the invention;

FIG. 2 is a section of the opening region of a first embodiment of the invention for receiving a measurement value sensor (left half of FIG. 2) and a forming cone used during the production of that opening region (right half of FIG. 2);

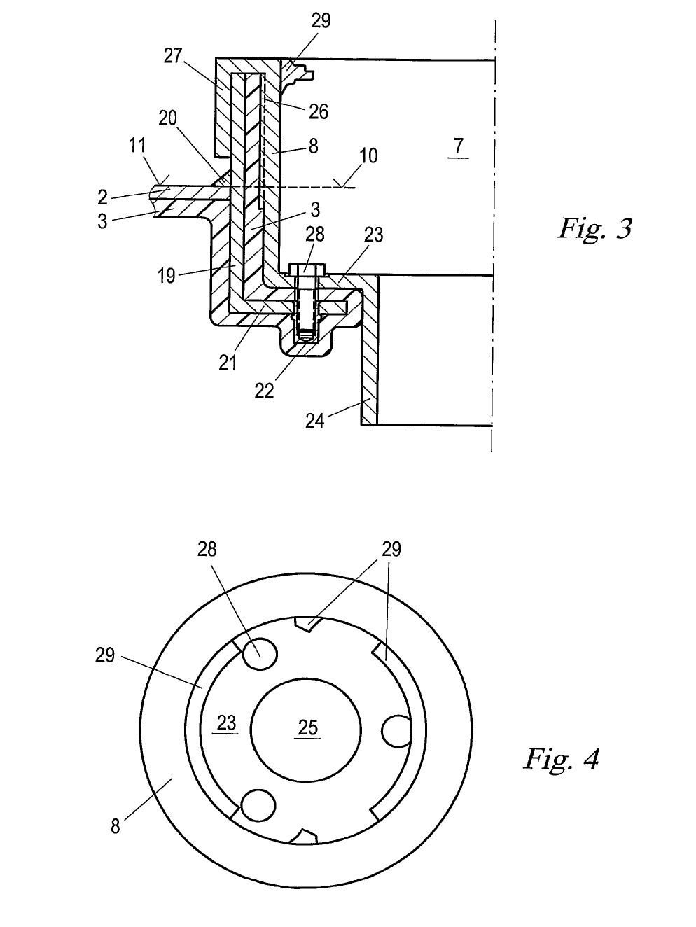

FIG. 3 is a section through the opening region of a second embodiment of the invention for receiving a filler neck; and

FIG. 4 is a top view of the filler neck of the embodiment of FIG. 4.

FIG. 1 shows a tank 1 which is intended to receive aggressive working fluids of motor vehicles, for example, a catalytic urea solution. The tank 1 may contain any fittings such as partition walls, surge walls, etc. (not illustrated) or also itself be only one chamber of a multiple-chamber tank whose other chambers are intended, for example, for fuel, etc.

The tank 1 has a wall 2 of metal, preferably aluminium. The metal wall 2 is provided at the inner side thereof with a plastics coating 3 which consequently lines the entire tank interior.

The plastics coating 3 is resistant to the working fluid to be received, in this instance urea solution. Suitable plastics materials for the plastics coating are, for example, polyolefins, such as HDPE (high density polyethylene), MDPE (middle density polyethylene), LDPE (low density polyethylene) or LLDPE (linear low density polyethylene).

The plastics coating 3 is produced in situ in the metal wall 2 by the rotolining method known in the art. To that end, plastics material in, for example, granular form is introduced into the tank via an opening, then the opening is closed and the tank is heated and rotated until the granulate melts as a plastics coating on the inner side of the metal wall 2.

As schematically illustrated first in FIG. 1, the tank 1 has a first opening 4 for a component 6 which extends into the tank 1 and which is provided with an end flange 5, for example, a suction line with filling level sensor and heating, and a second opening 7 for a filler neck 8 for securing a tank cover 9. The peripheral shape of the openings 4, 7 is of any desired shape, for example, polygonal, curved or preferably circular.

The construction in the region of the opening 4 is shown in detail in the left-hand half of FIG. 2. The plastics coating 3 extends through the opening 4, beyond the level 10 of the outer side 11 of the metal wall 2 and onto the region 12 of the outer side 11 located around the opening 4. The end flange 5 of the component 6 engages over the plastics coating 3 at the region 12 in close abutment.

For additional sealing, the end flange 5 is provided with an annular seal 13 which seals against the outwardly extending plastics coating 3. Screws 14 extend through the plastics coating 3 in the region 12 and engage in press-in nuts 15 which are pressed into the metal wall 2 in order to fix the end flange 5.

In a simplified embodiment (not illustrated), the plastics coating 3 could also extend only as far as the level 10 of the outer side 11 of the metal wall 2 and the end flange 5 of the component 6 is in close abutment directly at the region 12 (uncoated at that time).

The right-hand half of FIG. 2 shows an intermediate cutting operation during the production of the plastics coating 3 by rotolining. First, plugs 16 are inserted in the press-in nuts 15 in order to prevent plastics material from being introduced during the rotolining. Subsequently, a cavity 18 which encloses the region 12 mentioned is provided outside the opening 4 by means of a forming cone 17 which is positioned on the outer side of the metal wall 2 in order to also coat the region 12 during the rotolining. After the forming cone 17 has been removed, the plastics coating 3 is cut in accordance with the outer region 12 and the plugs 16 are exposed and removed. If plugs 16 which project beyond the outer side 11 are used (not shown), they do not need to be exposed separately but instead simply need to be unscrewed.

FIG. 3 shows an alternative construction of the plastics coating 3 extending out of the tank interior, in particular in order to mount a filler neck 8 in the opening 7.

First, a bush or sleeve 19 which is composed of plastics material or preferably metal and which projects beyond the outer side 11 of the metal wall 2 is introduced into the opening 7 of the metal wall 2 and welded, as indicated by the weld seam 20. The sleeve 19 has an internal projection 21 at the lower end thereof so that it has substantially the shape of a pot provided with a base opening. Press-in nuts 22 for subsequently securing the filler neck 8 are pressed into the internal projection 21.

During the rotolining step, the portion of the sleeve 19 projecting into the tank interior and the inner side of the sleeve 19 are coated so that the plastics coating 3 extends through the opening 7, beyond the level 10 of the outer side 11 of the metal wall 2 and at the inner side of the sleeve 19. Temporary plugs 16 can again be used to protect the press-in nuts 22 during the rotolining.

The filler neck 8 has an internal projection 23 which corresponds to the internal projection 21 of the sleeve 19 and which has an adjoining inner connecting piece 24 and is pressed into the plastics coating 3 at the inner side of the sleeve 19. The compression securing can be increased by an external thread 26 at the outer side of the filler neck 8, in which case the filler neck 8 is screwed in.

The outer end of the filler neck 8 is constructed to form a bent-over edge 27 which engages around the outer end of the sleeve 19 and its inner plastics coating 3. The filler neck 8 is fixed to the internal projection 21 of the sleeve 19 with screws 28 which extend through the internal projection 23 and the plastics coating 3 of the sleeve 19 and which engage in the press-in nuts 22.

The filler neck 8 can further be provided with clips 29 for the bayonet type securing of the tank cover 9. The filler neck 8 is preferably produced from a plastics material resistant to urea.

The invention is not limited to the embodiments illustrated but instead comprises all the variants and modifications, in particular any combinations of the embodiments shown which are included within the scope of the appended claims.

What is claimed is:

1. A tank for operating materials of motor vehicles comprising: a metal wall having at least one opening which is constructed therein the opening having a width smaller than the width of the tank; and a plastics coating on the inner side of the metal wall, wherein the plastics coating extends through the opening beyond the level of an outer side of the metal wall.

2. A tank according to claim 1, wherein the plastics coating is directed outwards in a U-like manner around the edge of the rim of the opening and is supported on the region of the outer side of the metal wall around the opening.

3. A tank according to claim 2, further comprising a component, which is received in the opening and extends into the tank and is provided with an end flange, which end flange engages over the plastics coating at the said region of the outer side.

4. A tank according to claim 3, wherein the end flange has a seal for abutment against the plastics coating in the region of the outer side.

5. A tank according to claim 1, wherein the tank has a sleeve which projects beyond the outer side of the metal wall and which is received in the opening and against the inner side of which the plastics coating abuts.

6. A tank according to claim 5, wherein the tank has a filler neck which is received by the sleeve and which is pressed into the plastics coating at the inner side of the sleeve.

7. A tank according to claim 6, wherein the filler neck is provided with an external thread and/or with external ribs for press-fit securing in the plastics coating.

8. A tank according to claim 6, wherein the filler neck has, at the outer end thereof, a bent-over edge which engages around the outer end of the sleeve with the plastics coating thereof.

9. A tank according to claim 6, wherein the sleeve and the filler neck have mutually complementary internal projections and the internal projection of the filler neck is fixed to the internal projection of the sleeve by way of fixing means which extend through the plastics coating.

10. A tank according to claim 1, wherein the metal wall is produced from aluminium.

11. A tank according to claim 1, wherein the plastics coating is formed by rotolining in situ on the metal wall.

12. A tank according to claim 1, wherein the plastics coating is resistant to urea solutions.
